(19) United States
(12) Patent Application Publication
(10) Pub. No.: US 2012/0179455 A1
(43) Pub. Date: Jul. 12, 2012

(54) LANGUAGE LEARNING APPARATUS AND METHOD USING GROWING PERSONAL WORD DATABASE SYSTEM

(75) Inventor: Minho CHA, Seoul (KR)

(73) Assignee: GOOD FINANCIAL CO., LTD., Seoul (KR)

(21) Appl. No.: 13/096,169

(22) Filed: Apr. 28, 2011

(30) Foreign Application Priority Data
Jan. 12, 2011 (KR) 10-2011-0003230

(51) Int. Cl. G06F 17/21

(52) U.S. Cl. 704/10; 704/E11.001

(57) ABSTRACT

Disclosed herein is a language learning apparatus and method using a growing personal word DB system, which construct an individual person-based word DB in which known words and unknown words are stored separately. The language learning apparatus includes a word extraction unit for extracting words included in learning content and generating a word list. A word analysis unit sets learning levels of words included in the word list based on a level-based word DB. A control unit generates an individual person-based word DB in which classification into known words and unknown words is performed and known words and unknown words are stored separately based on a learning level of a learner and the level-based word DB, and performs control such that the words included in the word list are classified into known words and unknown words and are stored separately based on the set learning level.

### CROSS REFERENCE TO RELATED APPLICATION

This application claims the benefit of Korean Patent Application No. 10-2011-0003230 filed on Jan. 12, 2011, which is hereby incorporated by reference in its entirety into this application.

### BACKGROUND OF THE INVENTION

1. Technical Field

The present invention relates generally to a language learning apparatus and method using a growing personal word database (DB) system, and, more particularly, to a growing personal word DB system and a service provision method using the DB system, in which individual person-based word DBs constructed for learners are associated with text data, thus improving the effects of word learning.

2. Description of the Related Art

With the development of electronic technology and the enhancement of the performance of mobile devices, an electronic dictionary for word learning is a basic component of most mobile devices. Learning using an electronic dictionary installed in a mobile device is only intended as a way to understand the meaning of words. Some electronic dictionaries assign a bookmark function for specific words via a learner's settings, or provide the function of fording words which have been recently searched for or the like. The function of such an electronic dictionary closely follows the original functions of the dictionary, and merely provides basic assistance by partially utilizing the functions of mobile devices. An online electronic dictionary provided via the Internet provides functions similar to those provided by the electronic dictionary of mobile devices.

Further, when content stored in a computer or a mobile terminal or content received via the Internet is written in a foreign language such as English, the meanings of some words may be provided using a mouse-over dictionary function to enhance a learner's understanding. In this case, target words on which a mouse-over function is executed are determined by levels or intentions that are set by content providers regardless of the word levels or intentions of individual learners. Therefore, this makes learners feel inconvenienced, and does not greatly assist the learners to learn words.

When a mouse-over dictionary function is used, a learner can learn the meaning of an unknown word, the meaning of which the learner does not know, by putting the mouse over the unknown word while reading text, but he or she cannot learn unknown words in the text in advance. That is, if necessary, it is possible to learn the meanings of words the learner does not know, but the effect of learning thereof is insignificant.

In the case of some reading content, the level of a learner is assumed to be a specific level, and a description of several words is separately presented. However, since this method does not take into consideration the fact that known words and unknown words differ among individual learners, it merely provides basic assistance to learning effects.

### SUMMARY OF THE INVENTION

Accordingly, the present invention has been made keeping in mind the above problems occurring in the prior art, and an object of the present invention is to provide a language learning apparatus and method using a growing personal word DB system, which construct an individual person-based word DB in which classification into words a learner knows and words the learner does not know is performed and known words and unknown words are stored separately, and which allow text data to be associated with the individual person-based word DB, thus improving the effects of word learning.

Another object of the present invention is to provide a language learning apparatus and method using a growing personal word DB system, which are configured such that when text written in a foreign language such as English books or English articles is displayed on a device such as a computer or a mobile terminal, the text is associated with an individual person-based word DB so that words a learner knows and words the learner does not know are separately displayed, and the learner can easily learn the words he or she does not know, thus improving the effects of language learning.

In order to accomplish the above objects, the present invention provides a language learning apparatus using a growing personal word database (DB) system, including a word extraction unit for extracting words included in learning content and generating a word list; a word analysis unit for setting learning levels of words included in the word list based on a level-based word DB; and a control unit for generating an individual person-based word DB in which classification into known words and unknown words is performed and the known words and the unknown words are stored separately based on a learning level of a learner and the level-based word DB, and performing control such that the words included in the word list are classified into known words and unknown words and are stored separately based on the set learning level.

Preferably, the language learning apparatus may further include an input unit for receiving the learning level of the learner and selection information required to classify words into known words and unknown words.

Preferably, the word analysis unit may classify the words included in the word list into known words and unknown words based on the set learning level.

Preferably, the word analysis unit may set words that are not stored in a basic word DB, among the words included in the word list, to unlearned words.

Preferably, the control unit may perform control such that words stored in a lower DB, set to a learning level equal to or less than that of the learner, in the level-based word DB are stored in a known word DB.

Preferably, the control unit may perform control such that words stored in a lower DB, set to a learning level greater than that of the learner, in the level-based word DB are stored in an unknown word DB.

Preferably, the control unit may display words classified as unknown words by the word analysis unit and request the learner to perform an adjustment operation.

Preferably, the control unit may set a learning level of learning content based on results of analysis by the word analysis unit.

Preferably, the language learning apparatus may further include a storage unit formed to have a structure identical to that of the individual person-based word DB and the known words and the unknown words are stored separately in the storage unit.

Preferably, the storage unit may include a known word storage module for storing words the learner knows; an unknown word storage module for storing words the learner does not know; an unlearned word storage module for storing words that are not stored in the basic word DB; and a personal level information storage module for storing information including the learning level of the learner.

Further, in order to accomplish the above objects, the present invention provides a language learning method using a growing personal word database (DB) system, including generating an individual person-based word DB in which classification into words a learner knows and words the learner does not know is performed and the known words and unknown words are stored separately based on a learning level of the learner and a level-based word DB; extending the generated individual person-based word DB using learning content selected by the learner; analyzing individual person-based learning history using both the individual person-based word DB and a personal learning history DB, and then generating analysis information; and changing growing personal word DBs based on the generated analysis information.

Preferably, the generating the individual person-based word DB may include setting the learning level of the learner; and detecting words corresponding to a learning level equal to or less than the set learning level of the learner from the level-based word DB and storing the detected words in a known word DB.

Preferably, the setting the learning level may be configured such that one of an input learning level and a learning level of words stored in the known word DB corresponding to the learner is set to the learning level of the learner.

Preferably, the generating the individual person-based word DB may be configured such that words corresponding to a learning level greater than the set learning level are detected from the level-based word DB and are stored in an unknown word DB.

Preferably, the extending the individual person-based word DB may include extracting a plurality of words from the learning content; storing words that are not stored in the basic word DB, among the extracted words, in an unlearned word DB of the individual person-based word DB; storing words corresponding to a learning level equal to or less than that of the learner, among the extracted words, in the known word DB; and storing words corresponding to a learning level greater than that of the learner, among the extracted words, in the unknown word DB.

Preferably, the extending the individual person-based word DB may further include storing words that are not stored in the basic word DB, among the extracted words, in the basic word DB of the individual person-based word DB.

Preferably, the storing the words in the unknown word DB may include displaying words corresponding to a learning level greater than that of the learner among the extracted words; setting words the learner knows, among the displayed words, to known words; storing the words which are set to the known words in the known word DB; and storing words which are not set to the known words, among the displayed words, in the unknown word DB.

Preferably, the analyzing the individual person-based learning history and generating the analysis information may include managing changed details of the individual person-based word DB; generating analysis information by analyzing the individual person-based word DB and an individual person-based learning history DB; and storing the generated analysis information in an individual person-based learning history analysis DB.

Preferably, the changing the growing personal word DBs may include changing the basic word DB based on analysis information stored in an individual person-based learning history analysis DB; resetting learning levels and areas of the words based on the analysis information; and re-classifying and storing the words based on the reset learning levels and areas.

Therefore, the language learning apparatus and method using the growing personal word DB system according to the present invention are advantageous in that the individual person-based word DB of each learner in which classification into known words and unknown words is performed and the known words and the unknown words are stored separately is constructed, and the individual person-based word DB is continuously extended through the interactive learning progress of the learner, thus improving the effects of language learning, and configuring and providing dynamic learning content in which differences among learners are reflected via dynamic association between words and text.

Further, the language learning apparatus and method using the growing personal word DB system are advantageous in that word learning services are provided using desired content (for example, e-books, theses, foreign language teaching materials, etc.) to respective learners, thus enhancing learning effects compared to conventional word learning services which use teaching materials produced by uniform standards.

Furthermore, the language learning apparatus and method using the growing personal word DB system are advantageous in that word learning services are provided using learning content such as e-books, theses, and foreign language teaching materials, thus creating the new profit model of publishing companies.

Furthermore, the language learning apparatus and method using the growing personal word DB system are advantageous in that services are provided through smartphones, tablet PCs, etc. in a mobile web environment, thus enabling language learning to be naturally associated with an increase in vocabulary in various environments.

Furthermore, the language learning apparatus and method using the growing personal word DB system are advantageous in that when foreign language text such as English books or English articles is displayed on devices such as a computer or a mobile terminal, words in the text are classified into words learner knows and words the learner does not know and are separately stored in conjunction with DBs, thus allowing the learner to easily learn words and improving the effects of language learning.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a growing personal word DB system according to an embodiment of the present invention;

FIGS. 2 and 3 are diagrams showing the level-based word DB of FIG. 1;

FIG. 4 is a diagram showing the individual person-based word DB of FIG. 1;

FIGS. 5 and 6 are diagrams showing a language learning apparatus using the growing personal word DB system according to an embodiment of the present invention;

FIG. 7 is a diagram showing the construction of the language learning apparatus of FIGS. 5 and 6;

FIG. 8 is a diagram showing the output unit of FIG. 7;

FIG. 9 is a diagram showing another construction of the language learning apparatus of FIGS. 5 and 6;

FIG. 10 is a diagram showing the storage unit of FIG. 9;

FIG. 11 is a flowchart showing a language learning method using the growing personal word DB system according to an embodiment of the present invention;

FIG. 12 is a flowchart showing an individual person-based word DB generation step;

FIGS. 13 to 16 are diagrams showing an individual person-based word DB extension step;

FIGS. 17 and 18 are diagrams showing the individual person-based learning history analysis step of FIG. 11; and

FIG. 19 is a flowchart showing the growing personal word DB change step of FIG. 11.

### DESCRIPTION OF THE PREFERRED EMBODIMENTS

Hereinafter, in order to describe the present invention in detail to such an extent that those skilled in the art can easily implement the technical spirit of the present invention, preferred embodiments of the present invention will be described in detail with reference to the attached drawings. It should be noted that the same reference numerals are used throughout the different drawings to designate the same or similar components as much as possible. If in the specification, detailed descriptions of well-known functions or configurations may unnecessarily make the gist of the present invention obscure, the detailed descriptions will be omitted. The embodiments of the present invention are provided to more completely describe the present invention to those skilled in the art. Therefore, the shapes and sizes of components in the drawings may be exaggerated for clearer descriptions.

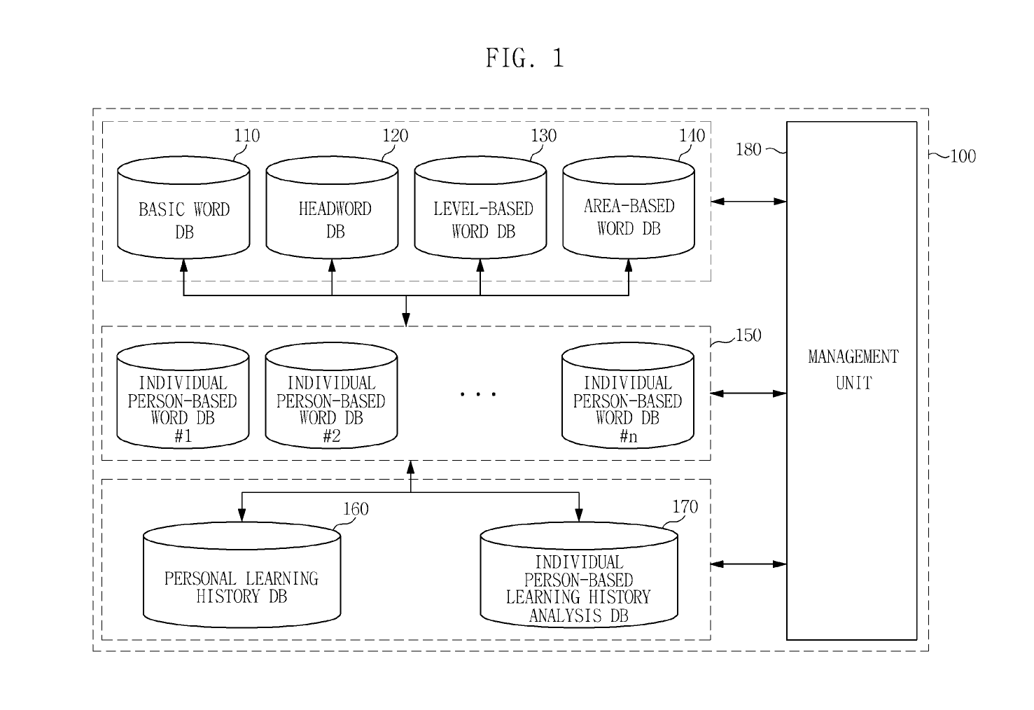

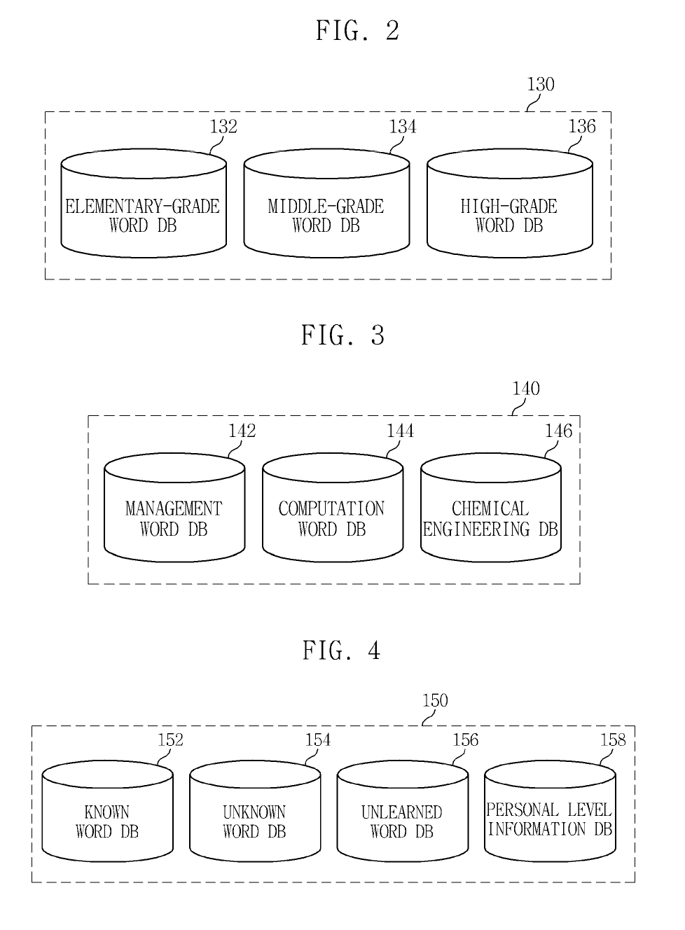

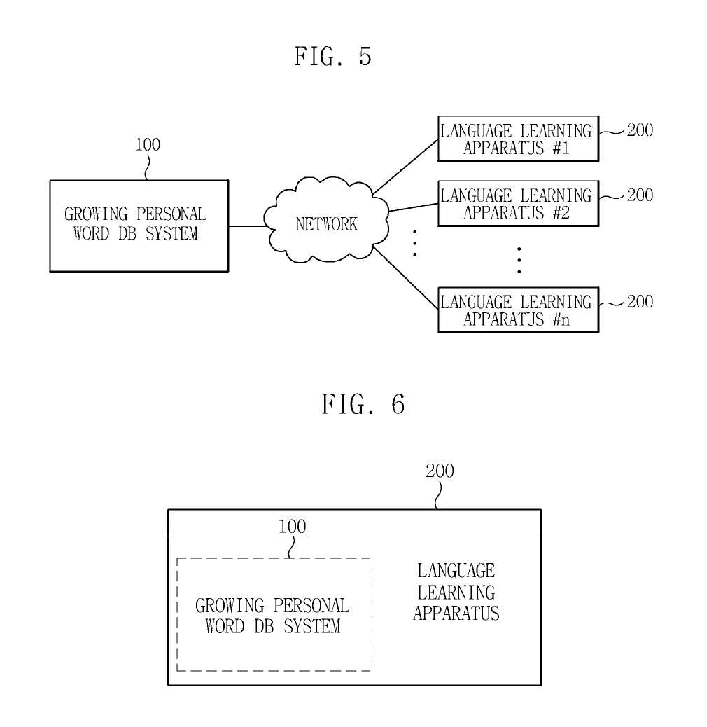

Hereinafter, a growing personal word DB system according to embodiments of the present invention will be described in detail with reference to the attached drawings. FIG. 1 is a diagram showing a growing personal word DB system according to an embodiment of the present invention. FIG. 2 is a diagram showing the level-based word DB of FIG. 1, FIG. 3 is a diagram showing the area-based word DB of FIG. 1, and FIG. 4 is a diagram showing the individual person-based word DB of FIG. 1.

As shown in FIG. 1, a growing personal word DB system 100 includes a basic word DB 110, a headword DB 120, a level-based word DB 130, an area-based word DB 140, individual person-based word DBs 150, a personal learning history DB 160, and an individual person-based learning history analysis DB 170. Here, the level-based word DB 130 and the area-based word DB 140 are included to facilitate the initial setting of each individual person-based word DB 150.

The basic word DB 110 stores words, contained in learning content provided to a learner (learning content held by a service provider), the meanings of the words, sentences, the meanings thereof, etc. As learning content is added, the basic word DB 110 may additionally store words or sentences contained in the learning content.

The headword DB 120 stores headwords which must be unconditionally stored as known words according to the learning level of the learner. The headword DB 120 classifies a plurality of headwords according to the learning level, and separately stores the classified headwords.

The level-based word DB 130 classifies a plurality of words included in the basic word DB 110 according to the learning level, and stores the classified words. For the plurality of words included in the basic word DB 110, corresponding learning levels are set depending on learning levels classified into the grade of an elementary school, the first grade of a middle school˜the third grade of a high school, TOEIC, TOEFL, TEPS, etc.

The level-based word DB 130 includes a plurality of lower DBs classified for respective learning levels. In each of the plurality of lower DBs, words set to the same learning level are stored. For example, as shown in FIG. 2, the level-based word DB 130 includes lower DBs classified into an elementary-grade word DB 132, a middle-grade word DB 134, and a high-grade word DB 136. In this case, the elementary-grade word DB 132 stores words set to the learning level of an elementary school. The middle-grade word DB 134 stores words set to the learning levels of first to third grades in a middle school. The high-grade word DB 136 stores words set to the learning levels of the first grade of a high school or higher.

The level-based word DB 130 may additionally store words as the number of words increases with the extension of the basic word DB 110 and the individual person-based word DB 150. That is, when new learning content including new words that are not stored in the basic word DB 110 is learned, the new words are stored in the basic word DB 110 and the individual person-based word DB 150, and then the DBs 110 and 150 are extended. In this case, the level-based word DB 130 stores new words to which learning levels are set depending on the results of the learning of the new words by the learner.

Learning levels set to the words stored in the level-based word DB 130 can change depending on the learning history and learning level of the learner. In this case, in the level-based word DB 130, storage locations at which a plurality of words are to be stored can change based on the changed learning levels.

The area-based word DB 140 classifies and stores a plurality of words included in the basic word DB 110 according to the usage area of the words. That is, the usage area of the words included in the basic word DB 110 is set depending on usage areas classified into the College Scholastic Ability Test, general conversation, management, medicine, engineering, computation, chemical engineering, etc.

The area-based word DB 140 is composed of a plurality of lower DBs classified for usage areas. Each of the plurality of lower DBs stores words set to the same usage area. For example, as shown in FIG. 3, the area-based word DB 140 includes lower DBs classified into a management word DB 142, a computation word DB 144, and a chemical engineering word DB 146. In this case, the management word DB 142 stores words, the usage area of which is set to ‘management’. The computation DB 144 stores words, the usage area of which is set to ‘computation’. The chemical engineering DB 146 stores words, the usage area of which is set to ‘chemical engineering’.

The area-based word DB 140 may additionally store words as the number of words stored in the basic word DB 110, the individual person-based word DB 150, etc. increases. That is, when new learning content including new words that are not stored in the basic word DB 110 is learned, the new words are stored in the basic word DB 110 and the individual person-based word DB 150, and then the DBs 110 and 150 are extended. In this case, the area-based word DB 140 stores new words, the usage areas of which are designed by the learner or are set depending on the fields of learning content.

The usage areas of the words stored in the area-based word DB 140 can be changed by the learner. In this case, the area-based word DB 140 can change the storage locations of a plurality of words based on the changed usage areas.

The individual person-based word DB 150 is a DB constructed in consideration of the learning level, learning area or the like of the learner in the basic word DB 110. The individual person-based word DB 150 classifies the words of the basic word DB 110 into unknown words, known words, and unlearned words according to the learning level or learning area of the learner, and stores the classified words. The individual person-based word DB 150 stores information about the learning level of the learner. For this function, as shown in FIG. 4, the individual person-based word DB 150 includes a known word DB 152, an unknown word DB 154, an unlearned word DB 156, and a personal level information DB 158. The known word DB 152 stores words marked as ‘known words’ in learning content which the learner has learned to date. The unknown word DB 154 stores words marked as ‘unknown words’ in the learning content which the learner has learned to date. The unlearned word DB 156 stores words the learner has never learned on the basis of the current learning content. The personal level information DB 158 stores the learning level of the learner.

The individual person-based word DB 150 stores words corresponding to the learning level set by the learner in the known word DB 152. The individual person-based word DB 150 also stores words corresponding to a learning level lower than that set by the learner in the known word DB 152. The individual person-based word DB 150 stores words corresponding to a learning level higher than that set by the learner in the unknown word DB 154. The individual person-based word DB 150 stores the learning level set by the learner in the personal level information DB. For example, when the learner knows words corresponding to a middle grade, and then selects his or her level as a middle grade level, the individual person-based word DB 150 stores words corresponding to the elementary grade level and the middle grade level, among the words stored in the level-based word DB 130, in the known word DB 152. In this case, words corresponding to the high grade level may be stored in the unknown word DB 154. Of course, words may not be stored in the unknown word DB 154, and the unknown word DB 154 may be initialized.

With the learning progress of the learner, the individual person-based word DB 150 additionally stores new words or enables words stored in the unknown word DB 154 to be transferred to and stored in the known word DB 152. The individual person-based word DB 150 receives changed contents from a language learning apparatus 200 which will be described later, and stores the received contents.

The personal learning history DB 160 stores information about the personal learning history of each learner. The personal learning history DB 160 stores personal learning history information including learning frequency (a period and the number of times), the results of a check-up test, etc.

The individual person-based learning history analysis DB 170 stores analysis information obtained by performing multidimensional analysis on the individual person-based word DB 150 and the personal learning history DB 160. Here, the individual person-based learning history analysis DB 170 is used as data required to adjust the levels of words stored in the headword DB 120, the level-based word DB 130, the area-based word DB 140, etc.

The individual person-based learning history analysis DB 170 analyzes the individual person-based word DB 150 and the personal learning history DB 160 at predetermined periods (for example, per day, per week, or the like) with respect to all learners, and stores analyzed information generated by such analysis. In this case, the individual person-based learning history analysis DB 170 analyzes analyzed information including the frequency of word learning, the frequency of a word test, the frequency of the use of each word, etc.

The management unit 180 adds or deletes basic words to or from the basic word DB 110 on the basis of the analyzed information stored in the individual person-based learning history analysis DB 170. The management unit 180 readjusts the areas of the words stored in the area-based word DB 140 on the basis of the analyzed information. The management unit 180 classifies and stores the words depending on the readjusted areas. The management unit 180 readjusts the learning levels of the words stored in the level-based word DB 130 on the basis of the analyzed information. The management unit 180 classifies and stores the words depending on the readjusted learning levels.

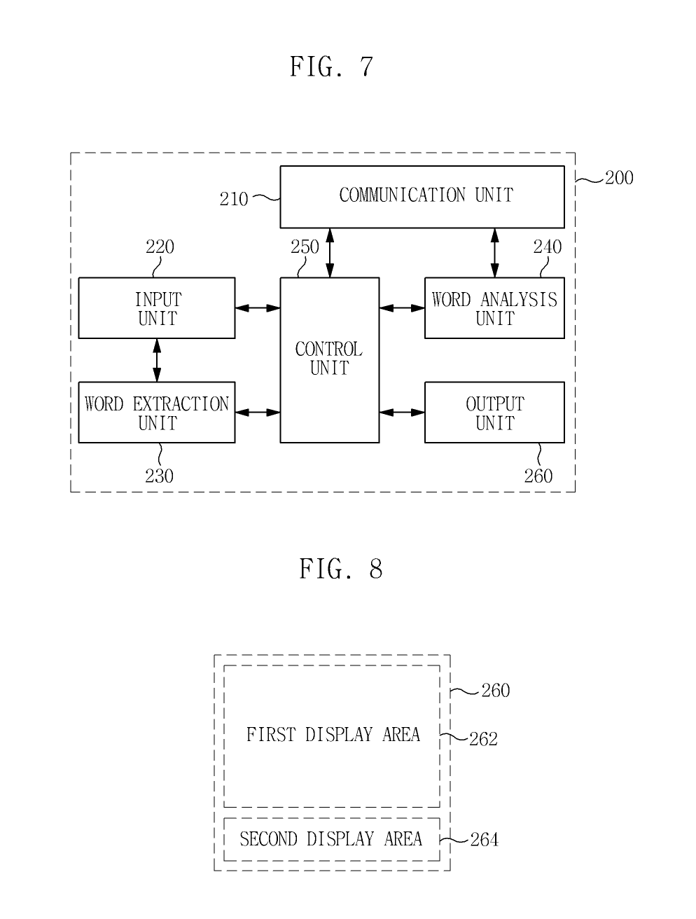

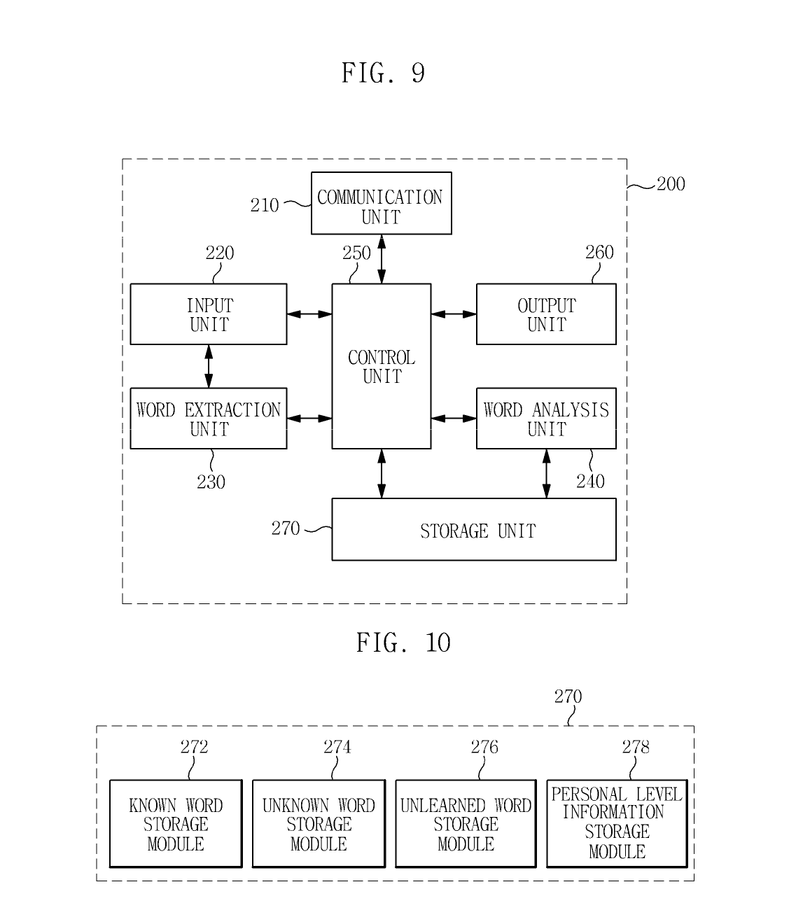

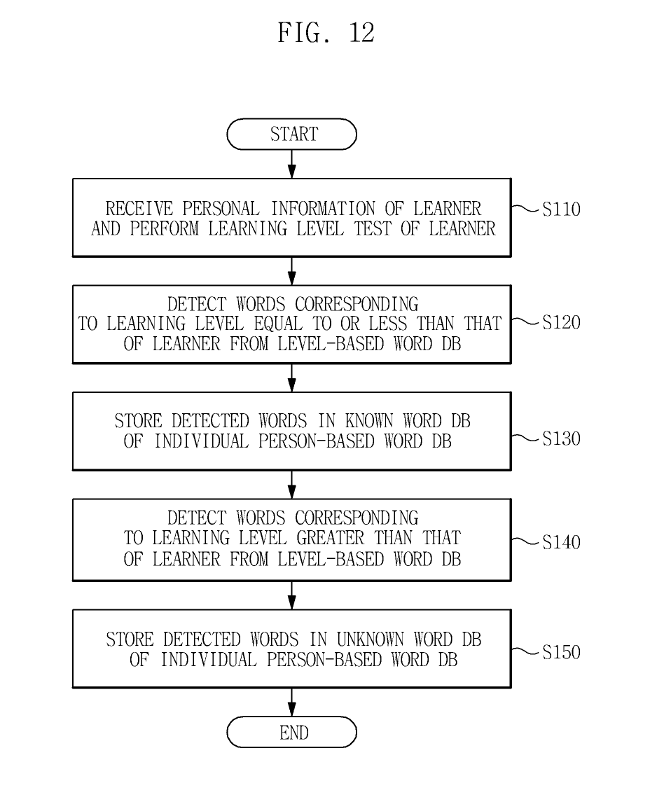

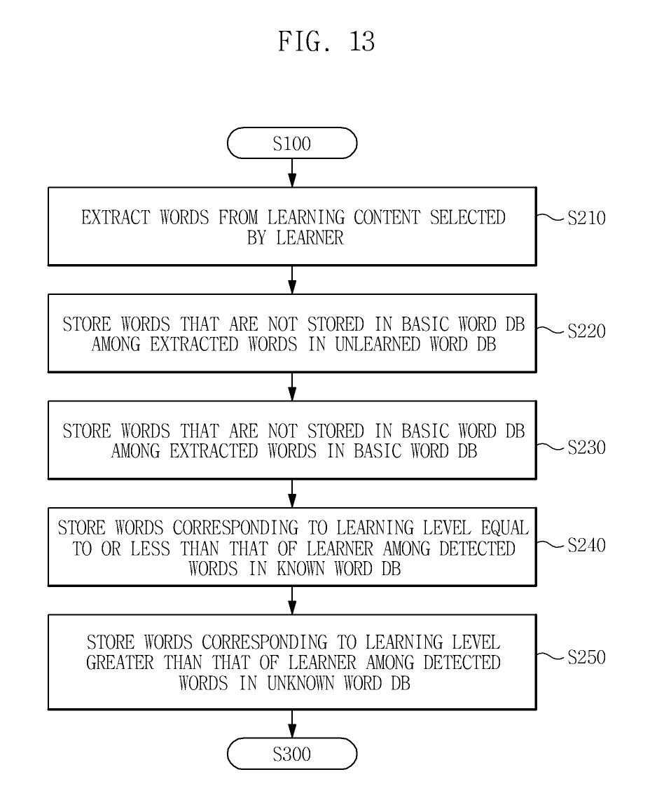

Hereinafter, a language learning apparatus using the growing personal word DB system according to an embodiment of the present invention will be described in detail with reference to the attached drawings. FIGS. 5 and 6 are diagrams showing a language learning apparatus using the growing personal word DB system according to an embodiment of the present invention. FIG. 7 is a diagram showing the construction of the language learning apparatus of FIGS. 5 and 6, and FIG. 8 is a diagram showing the output unit of FIG. 7. FIG. 9 is a diagram showing another construction of the language learning apparatus of FIGS. 5 and 6. FIG. 10 is a diagram showing the storage unit of FIG. 9.

As shown in FIG. 5, language learning apparatuses 200 are connected to the growing personal word DB system 100 over a network. That is, the growing personal word DB system 100 and the language learning apparatuses 200 are formed in a server-client structure, so that information related to language learning is stored in the growing personal word DB system 100. In this case, the growing personal word DB system 100 is connected to one or more language learning apparatuses 200 and is configured to allocate respective individual person-based word DBs 150 to the language learning apparatuses 200 and manage the allocated individual person-based word DBs 150.

Meanwhile, as shown in FIG. 6, a language learning apparatus 200 may be integrated with the growing personal word DB system 100 into a single device. That is, the language learning apparatus 200 may be implemented as a smartphone, a tablet computer or a notebook computer which includes the DB structure of the growing personal word DB system 100.

As shown in FIG. 7, the language learning apparatus 200 includes a communication unit 210, an input unit 220, a word extraction unit 230, a word analysis unit 240, a control unit 250, and an output unit 260.

The communication unit 210 transmits or receives data related to language learning to or from the growing personal word DB system 100. The communication unit 210 is connected to the growing personal word DB system 100 over a wired/wireless network. Here, when the growing personal word DB system 100 and the language learning apparatus 200 are integrated into a single device, the communication unit 210 may be omitted.

The input unit 220 receives a learning level required to generate the individual person-based word DB 150 of a relevant learner. That is, the input unit 220 receives one of a plurality of learning levels set by the level-based word DB 130.

The input unit 220 receives selection information required to classify words into known words and unknown words. That is, the input unit 220 receives selection information required to select known words or to select unknown words from among displayed words.

The word extraction unit 230 extracts words from learning content. That is, the word extraction unit 230 automatically or manually extracts words contained in the learning content selected by the learner. In this case, the word extraction unit 230 downloads learning content such as Electronic books (e-books), theses, or foreign language teaching materials via the Internet, or receives the learning content from the learner or a service provider.

The word extraction unit 230 transmits the extracted words to the control unit 250. In this case, the word extraction unit 230 may transmit a word list created using the extracted words to the control unit 250.

The word analysis unit 240 determines based on words stored in the basic word DB 110 whether to set the extracted words to ‘unlearned words’ (or ‘new words’). In this case, the word analysis unit 240 sets words which are not stored in the basic word DB 110, among the extracted words, to ‘unlearned words (or new words)’.

The word analysis unit 240 sets the learning levels of the words extracted by the word extraction unit 230 based on the words stored in the level-based word DB 130. That is, the word analysis unit 240 compares the extracted words with the words stored in the level-based word DB 130 for individual learning levels, and then sets the learning levels of the extracted words.

The word analysis unit 240 classifies the words to which learning levels have been set into known words and unknown words on the basis of the individual person-based word DB 150. That is, the word analysis unit 240 classifies the words into known words and unknown words based on the learning level of the learner stored in the personal level information DB 158. In this case, the word analysis unit 240 determines that words set to a learning level equal to or less than that of the learner are known words. The word analysis unit 240 determines that words set to a learning level greater than that of the learner are unknown words.

The control unit 250 generates the individual person-based word DB 150 based on the learning level of the learner which is input through the input unit 220. The control unit 250 performs control such that the individual person-based word DB 150 of the learner is generated. The control unit 250 performs control such that words stored in a lower DB, which is set to the learning level equal to or less than that of the learner in the level-based word DB 130, are stored in the known word DB 152. In this case, the control unit 250 may perform control such that words stored in a lower DB, which is set to the learning level greater than that of the learner in the level-based word DB 130, are stored in the unknown word DB 154.

The control unit 250 may set the learning level of the learner based on the words stored in the level-based word DB 130, and generate the individual person-based word DB 150 based on the learning level. That is, the control unit 250 performs a check-up test using words stored in the level-based word DB 130, and then sets the learning level of the learner. Here, the term ‘check-up test’ refers to a test for providing questions, generated by detecting words at the same learning level, to the learner and setting the learning level of the learner based on the answers of the learner. In this case, the control unit 250 sets a learning level at which a percentage of correct answers is about 70% or higher to the learning level of the learner. For example, when a percentage of correct answers is 90% at the elementary grade level, is 75% at the middle grade level, and is 65% at the high grade level, the control unit 250 determines the learning level of the learner to be the middle grade level.

The control unit 250 transmits the words extracted from learning content by the word extraction unit 230 to the word analysis unit 240 and performs control such that the learning level is set. The control unit 250 performs control such that words set to unlearned words by the word analysis unit 240 are stored in the unlearned word DB 156 of the individual person-based word DB 150. The control unit 250 performs control such that words classified as known words by the word analysis unit 240 are stored in the known word DB 152.

The control unit 250 displays words classified as unknown words by the word analysis unit 240, and then requests the learner to perform an adjustment operation. That is, the control unit 250 performs control such that a list of unknown words (word 1, word 2, . . . ) is displayed on a screen. If known words are present in the displayed word list, the learner designates the words as known words using the input unit 220. The control unit 250 performs control such that words designated as known words by the learner are stored in the known word DB. The control unit 250 performs control such that words that are not designated as known words are stored in the unknown word DB 154.

The control unit 250 may set the learning level of learning content based on the results of the analysis by the word analysis unit 240. That is, the control unit 250 receives the learning levels of words contained in the learning content from the word analysis unit 240. The control unit 250 sets a learning level, which corresponds to the highest percentage among the learning levels of the words contained in the learning content, to the learning level of the learning content. For example, as the result of the reception of the learning levels of the words contained in learning content, if a percentage of words at the elementary grade level is 20%, a percentage of words at the middle grade level is 50%, and a percentage of words at the high grade level is 30%, the control unit 250 sets the learning level of the learning content to the middle grade level.

The control unit 250 performs control such that the learning content selected by the learner is displayed. In this case, the control unit 250 performs control such that the details of the learning content are displayed at the same time that a list of unknown words is displayed in a portion of the learning content. By means of this function, since only actually unknown words among the words contained in the learning content are displayed in the unknown word list, the effects of learning can definitely be obtained.

The output unit 260 displays a screen for language learning under the control of the control unit 250. That is, the output unit 260 displays the screen related to the generation of the individual person-based word DB 150, a check-up test screen required to determine the learning level of the learner, etc.

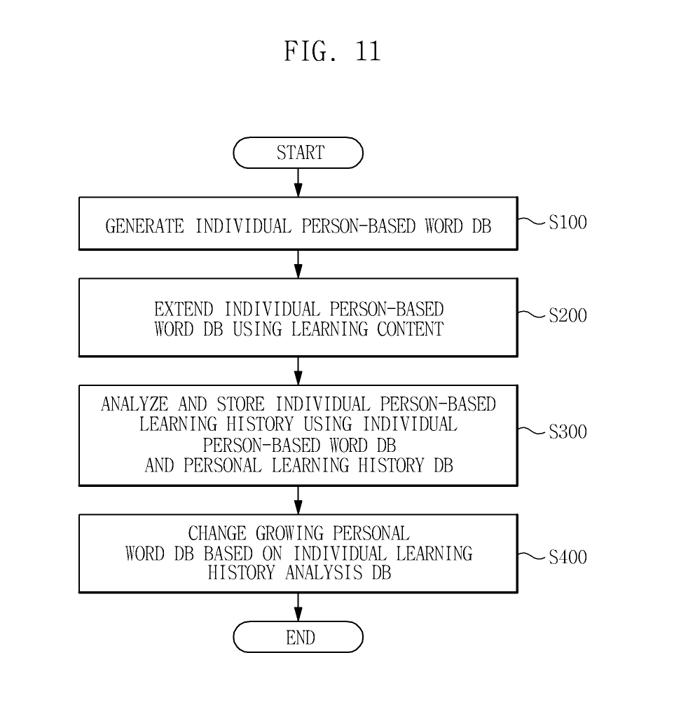

The output unit 260 displays the details of the learning content and the unknown word list under the control of the control unit 250. That is, as shown in FIG. 8, the output unit 260 divides a display area into a first display area 262 and a second display area 264, outputs and displays the details of the learning content in the first display area 262, and outputs and displays unknown words in the second display area 264.

As shown in FIG. 9, the language learning apparatus 200 may further include a storage unit 270. The storage unit 270 is formed in the same structure as the individual person-based word DB 150 of the growing personal word DB system 100. That is, as shown in FIG. 10, the storage unit 270 includes a known word storage module 272 for storing words the learner knows, an unknown word storage module 274 for storing words the learner does not know, an unlearned word storage module 276 for storing words that are not stored in the basic word DB 110, and a personal level information storage module 278 for storing information including the learning level of the learner.

In this case, the control unit 250 controls synchronization between the storage unit 270 and the growing personal word DB system 100. That is, the control unit 250 periodically transmits data stored in the storage unit 270 to the growing personal word DB system 100, and then synchronizes the storage unit 270 with the growing personal word DB system 100. Here, the control unit 250 synchronizes the known word DB 152 with the known word storage module 272, the unknown word DB 154 with the unknown word storage module 274, and the unlearned word DB 156 with the unlearned word storage module 276.

When the learner initially begins learning after the adjustment of words has been performed by the growing personal word DB system 100, the control unit 250 downloads data from the growing personal word DB system 100 and stores the data in the storage unit 270. That is, the learning level of the learner changes according to the learning progress of the learner, so that the readjusted data is downloaded and stored.

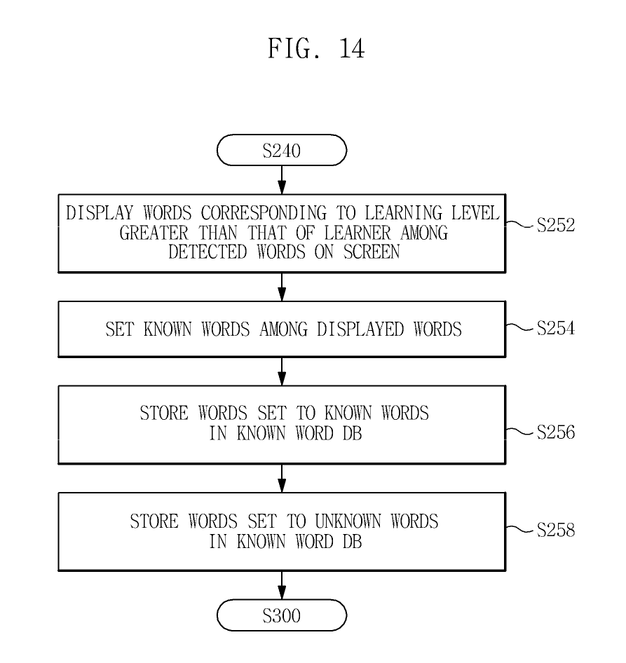

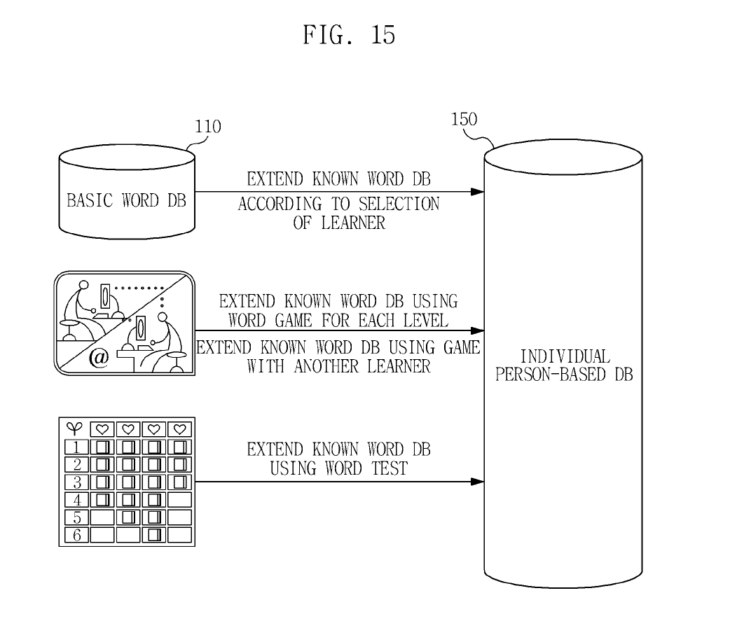

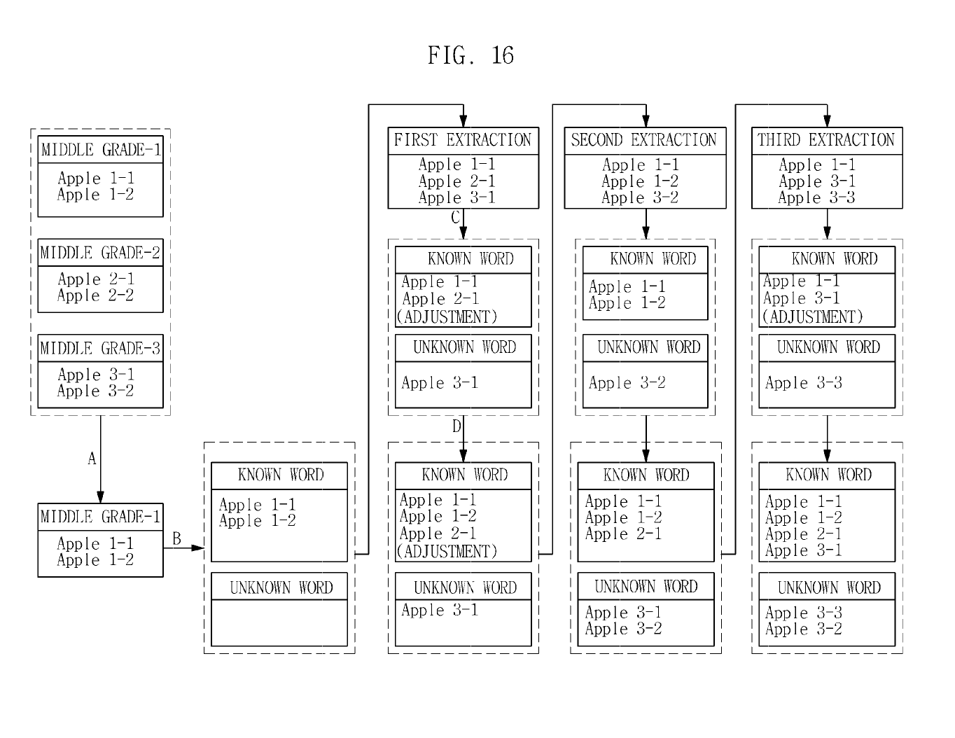

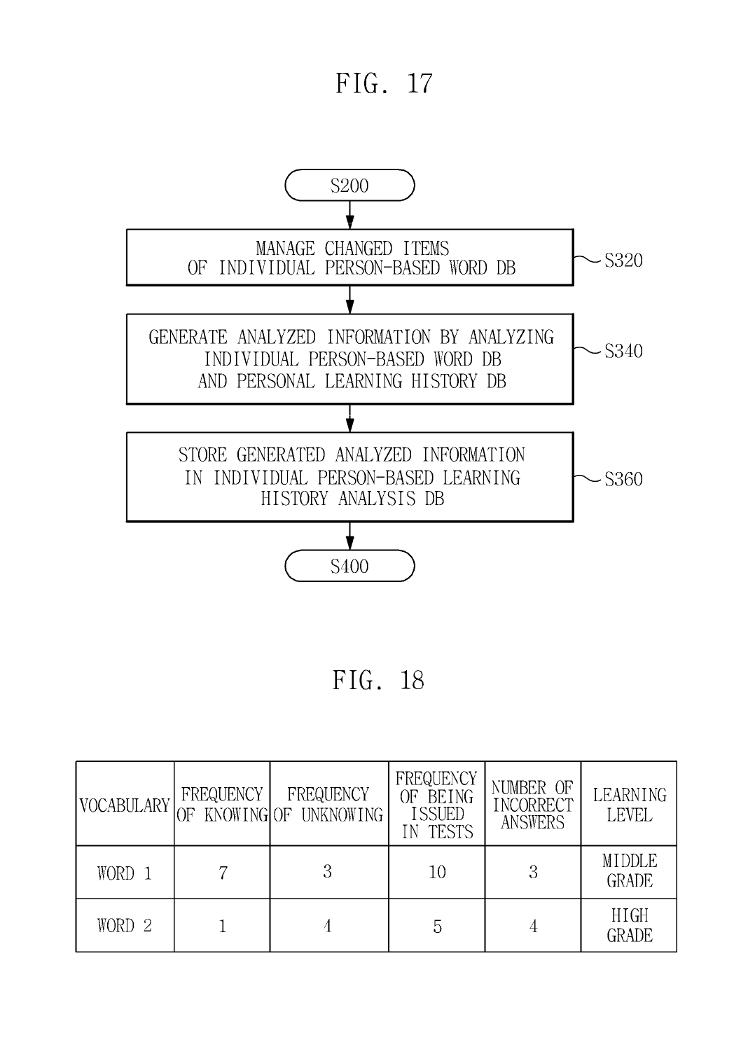

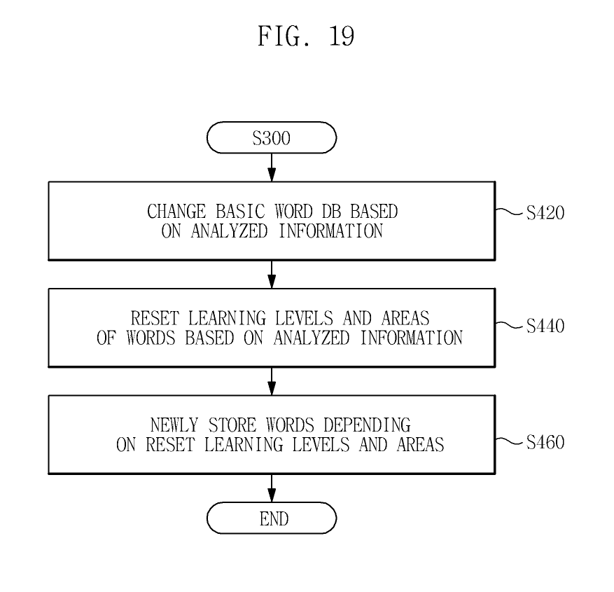

Hereinafter, a language learning method using the growing personal word DB system according to an embodiment of the present invention will be described in detail with reference to the attached drawings. FIG. 11 is a flowchart showing a language learning method using the growing personal word DB system according to an embodiment of the present invention. FIG. 12 is a flowchart showing an individual person-based word DB generation step, and FIGS. 13 to 16 are diagrams showing an individual person-based word DB extension step. FIGS. 17 and 18 are diagrams showing the individual person-based learning history analysis step of FIG. 11. FIG. 19 is a flowchart showing the growing personal word DB change step of FIG. 11.

First, the language learning apparatus 200 classifies the words stored in the level-based word DB 130 into known words and unknown words on the basis of the learning level of the learner and separately stores the classified words so as to perform language learning, thus generating the individual person-based word DB 150 at step S100. A method of generating the individual person-based word DB 150 will be described in detail below with reference to the attached drawings.

As shown in FIG. 12, the language learning apparatus 200 sets the learning level of the learner by receiving the personal information of the learner and conducting a learning level test on the learner at step S110. The language learning apparatus 200 sets the learning level input from the learner to the learning level of the relevant learner. The language learning apparatus 200 may set the learning level of the learner based on words stored in the level-based word DB 130. That is, the control unit 250 performs a check-up test using the words stored in the level-based word DB 130, and then sets the learning level of the learner. In this case, the check-up test refers to a test for detecting words at the same learning level, generating questions, providing the questions to the learner, and setting the learning level of the learner based on the answers of the learner to the questions. In this case, the control unit 250 sets a learning level, at which a percentage of correct answers is about 70% or higher, to the learning level of the learner. For example, when a percentage of correct answers is 90% at the elementary grade level, is 75% at the middle grade level, and is 65% at the high grade level, the control unit 250 sets the learning level of the learner to the middle grade level.

The language learning apparatus 200 detects words corresponding to a learning level equal to or less than the set learning level at step S120. In this case, the language learning apparatus 200 detects words from a lower DB, which is set to a learning level equal to or less than that of the learner, among the lower DBs of the level-based word DB 130.

The language learning apparatus 200 stores the detected words in the known word DB 152 of the individual person-based word DB 150 at step S130. That is, the language learning apparatus 200 determines words corresponding to the learning level equal to or less than that of the learner to be words which the learner has already learned or knows, and then stores the words in the known word DB 152.

The language learning apparatus 200 detects words corresponding to a learning level greater than the set learning level at step S140. In this case, the language learning apparatus 200 detects words from a lower DB set to the learning level greater than that of the learner among the lower DBs of the level-based word DB 130.

The language learning apparatus 200 stores the detected words in the unknown word DB 154 of the individual person-based word DB 150 at step S150. That is, the language learning apparatus 200 sets words corresponding to the learning level greater than that of the learner to the words the learner does not know.

Words included in the learning content selected by the learner are extracted. The extracted words are classified into words the learner knows and words the learner does not know and are then stored separately in respective DBs, so that the previously generated individual person-based word DB 150 is extended at step S200. In this case, the method of extending the individual person-based word DB 150 will be described in detail below with reference to the attached drawings.

As shown in FIG. 13, the language learning apparatus 200 extracts words from learning content selected by the learner so as to extend the individual person-based word DB 150 at step S210. That is, the language learning apparatus 200 extracts all words included in the learning content from the learning content. The language learning apparatus 200 deletes the words stored in the headword DB 120 from the extracted words.

The language learning apparatus 200 detects words that are not stored in the basic word DB 110 from the extracted words, and stores the detected words in the unlearned word DB 156 of the individual person-based word DB 150 at step S220.

Together with this operation, the language learning apparatus 200 may detect words that are not stored in the basic word DB 110 from the extracted words, and store the detected words in the basic word DB 110 at step S230.

The language learning apparatus 200 stores words corresponding to a learning level which is equal to or less than that of the learner, among the detected words, in the known word DB 152 at step S240.

The language learning apparatus 200 stores words corresponding to a learning level which is greater than that of the learner, among the detected words, in the unknown word DB 154 at step S250. In this case, in order to consider words the learner knows among the words corresponding to the learning level greater than that of the learner, the language learning apparatus 200 may request the learner to set words the learner knows among the detected words to ‘known words’.

For this operation, the language learning apparatus 200 displays words, corresponding to the learning level greater than that of the learner among the detected words, on the screen at step S252. That is, the language learning apparatus 200 displays the words on the screen to allow the learner to set words he or she knows to ‘known words’.

When the learner sets the words he or she knows among the words displayed on the screen to ‘known words’ at step S254, the language learning apparatus 200 stores the words set to ‘known words’ in the known word DB 152 at step S256.

The language learning apparatus 200 stores words set to ‘unknown words’ in the unknown word DB 154 at step S268. That is, the language learning apparatus 200 sets the remaining words other than the words set to ‘known words’, among the displayed words, to ‘unknown words’ and stored those words in the unknown word DB 154. In this case, as shown in FIG. 15, the individual person-based word DB 150 may be extended in such a way that the learner personally classifies words into known words and unknown words using a tool and separately stores the classified words, or that the learner classifies words into known words and unknown words by playing a word game for levels or a game with another learner or by performing a word test and then stores the separated words. The language learning apparatus 200 may reset known words and unknown words through a check-up test and reflect these results after the learner has learned words he or she did not know.

That is, when the learner selects a DB corresponding to his or her learning level from the level-based word DB 130 which stores words classified according to the learning level, the language learning apparatus 200 stores words, stored in the DB selected by the learner, in the known word DB 152 allocated to the learner, and then generates the known word DB 152 of the learner. In this case, the language learning apparatus 200 may store words stored in DBs, which are not selected by the learner, in the unknown word DB 154 of the learner.

Next, the language learning apparatus 200 generates the individual person-based word DB 150 of the learner using a game for word learning levels. That is, the language learning apparatus 200 provides a plurality of word questions at each learning level to the learner using various types of games from the words classified according to the learning level. The language learning apparatus 200 checks the learner's percentage of correct answers (or percentage of incorrect answers) at each learning level. When the learner's percentage of correct answers is about 70% or higher (the percentage of incorrect answers is less than about 30%) in the word questions at a relevant learning level, common words included in the relevant learning level are stored in the known word DB 152 of the learner.

Further, the language learning apparatus 200 may set the learning level of the learner using a winning average in a game between learners, and store words corresponding to the set learning level in the known word DB 152 of the relevant learner, thus generating the known word DB 152. For example, learner 1 having learning level A and learner 2 having learning level B play a game to conduct word learning. In this case, when the winning average of the learner 2 is about 70% or higher, the learner 2 is set to the learning level A. Accordingly, the language learning apparatus 200 detects words corresponding to the learning level A from the basic word DB 110, and then generates the known word DB 152 of the learner 2.

Alternatively, the language learning apparatus 200 may generate the known word DB 152 of the learner using a word learning level-based test. In detail, the language learning apparatus 200 provides questions related to words stored in the basic word DB 110 to the learner. When the learner gives correct answers to relevant words, the language learning apparatus 200 stores the words in the known word DB 152, whereas when the learner gives incorrect answers, the language learning apparatus 200 stores the words in the unknown word DB 154, thus generating the individual person-based word DB 150 of the learner.

After the extension of the individual person-based word DB 150 has been completed, the language learning apparatus 200 periodically transmits the changed contents (for example, learning history, the individual person-based word DB 150, additional words (new word), etc.) to the growing personal word DB system 100.

An example of the step of generating and extending the individual person-based word DB 150 will be described in detail below with reference to FIG. 16.

The learner selects his or her level from the level-based word DBs which are classified into middle grade-1, middle grade-2, and middle grade-3 to generate the individual person-based word DB, so that the individual person-based word DB is generated. For example, when the learner selects the level corresponding to the middle grade-1, words Apple 1-1 and Apple 1-2 belonging to the middle grade-1 are stored in the known word DB that is initially constructed, and then the individual person-based word DB is generated.

Further, it is assumed that the learner selects specific text content, and a first extraction operation is performed from the content to allow three words Apple 1-1, Apple 2-1, and Apple 3-1 to be extracted. Of these words, the word present in the known word DB is only Apple 1-1, and thus words Apple 2-1 and Apple 3-1 are extracted as words the learner does not know. When the learner performs an adjustment procedure, and sets Apple 2-1 to a known word, the words Apple 1-1 and Apple 2-1 (although not shown in the drawing, the initially stored Apple 1-2 is also stored) are stored in the known word DB of the individual person-based word DB, and then Apple 3-1 is stored in the unknown word DB. When the above text content is provided to the learner, it is consequently provided with the word Apple 3-1 included in an unknown word list.

Further, it is assumed that the learner selects another text content, and a second extraction operation is performed on this content to allow three words Apple 1-1, Apple 1-2, and Apple 3-2 to be extracted. Of these words, words present in the known word DB are Apple 1-1 and Apple 1-2, only the word Apple 3-2 is extracted as an unknown word. When the learner does not designate Apple 3-2 as a known word, Apple 3-2 is added to the unknown word DB of the individual person-based word DB.

It is assumed that the learner selects the other text content, and a third extraction operation is performed on this content to allow three words Apple 1-1, Apple 3-1, and Apple 3-3 to be extracted. Of these words, the only word present in the known word DB is Apple 1-1, and thus Apple 3-1 and Apple 3-3 are extracted as words the learner does not know. However, it is assumed that the learner learns Apple 3-1, which was originally present in the unknown word DB, and designates the word ‘Apple 3-1’ as a known word by performing an adjustment procedure. In this case, Apple 3-1 which was stored in the unknown word DB is moved to the known word DB, and Apple 3-3 is newly and additionally stored in the unknown word DB.

In this case, the individual person-based learning history is analyzed using both the individual person-based word DB 150 and the personal learning history DB 160, and then analysis information is generated. The generated analyzed information is stored in the individual person-based learning history analysis DB 170 at step S300. For example, the growing personal word DB system analyzes the individual person-based word DB 150 and the personal learning history DB 160 during the early hours of the morning once a day for all learners, and then updates the individual person-based learning history analysis DB 170. A method of generating and storing the analysis information will be described in detail below with reference to the attached drawings.

As shown in FIG. 17, the growing personal word DB system manages changed details of the individual person-based word DB 150 at step S320. That is, the growing personal word DB system periodically receives the changed details of the individual person-based word DB 150 from the language learning apparatus 200. The growing personal word DB system analyzes the personal learning history based on the received changed details, and stores the analysis information in the personal learning history DB.

The growing personal word DB system analyzes the individual person-based word DB 150 and the personal learning history DB, and then generates analysis information at step S340. In this case, as shown in FIG. 18, the growing personal word DB system generates analysis information including the frequency at which learners know each word, the frequency at which the learners do not know each word, the frequency of each word issued in tests, the number of times the learners gave incorrect answers to each word, a learning level, etc.

The growing personal word DB system stores the generated analysis information in the individual person-based learning history analysis DB 170 at step S360.

The learning levels or areas of the stored words are reset based on the analysis information stored in the individual person-based learning history analysis DB, and then the growing personal word DBs are changed at step S400. That is, the growing personal word DB system changes the levels of the words stored in the basic word DB 110 using words stored in the individual person-based word DB allocated to each learner. In detail, the growing personal word DB system analyzes the words separately stored in the known word DBs 152 and the unknown word DBs 154 included in the individual person-based DBs of all learners, and generates analysis data for each word, such as the frequency at which learners know each word, the frequency at which learners do not know each word, the frequency of each word issued in tests, the number of times the learners gave incorrect answers to each word, and the level of each word. The growing personal word DB system can change the level of each word using the generated analysis data, or change the range of levels that are divided (for example, the range of levels divided into level 1 to level 10 changes to the range of level 1 to level 100). For example, the TOEIC word DB of the area-based word DB 140 generates analysis data including the frequency at which learners know each word, the frequency at which the learners do not know each word, the frequency of each word issued in tests, the number of times the learners gave incorrect answers to each word, and the level of each word, the age of each learner, etc. with respect to all words included in the TOEIC word DB on the basis of the individual person-based word DBs of all learners. In this case, when the frequency at which learners know a relevant word belonging to level 1 is high, and the number of times the learners gave incorrect answers to the word is low, the growing personal word DB system downwardly adjusts the level of the relevant word. When the frequency at which learners know a relevant word belonging to level 2 is low and the number of times the learners gave incorrect answers to the word is high, the growing personal word DB system upwardly adjusts the level of the relevant word. In this case, the growing personal word DB system performs multidimensional analysis on all words stored therein and uses the results of the analysis as a basic DB used to provide various types of additional services.

Hereinafter, the method of changing growing personal word DBs will be described in detail with reference to the attached drawings.

The growing personal word DB system changes the basic word DB based on the analysis information at step S420. That is, the growing personal word DB system additionally stores the words, stored in the unlearned word DB 156 of the individual person-based word DB 150, in the basic word DB.

The growing personal word DB system resets the learning levels and areas of the stored words based on the analysis information at step S440. In detail, the growing personal word DB system resets the learning levels and areas of the words stored in the level-based word DB 130 and the area-based word DB 140.

The growing personal word DB system newly stores the words depending on the reset learning levels and areas at step S460. That is, the growing personal word DB system classifies the words according to the reset learning level and then reconstructs the level-based word DB 130. The growing personal word DB system classifies the words according to the reset area and then reconstructs the area-based word DB 140.

The above-described embodiment has been described such that unknown words are extracted from learning content and are then adjusted in advance. However, it is also possible to display extracted unknown words at the same time that the learning content is displayed, and to update the known word DB 152 and the unknown word DB 154 in such a way that the learner designates and checks words the learner knows. Further, for example, while English articles are displayed, words that are not stored in the known word DB 152 are displayed as unknown words in such a way as to be represented in a different color or emphasized with reference to the individual person-based word DB 150. Thereafter, when the learner puts a mouse over the unknown words, the unknown words can be checked as known words at the same time that the meanings of the words are provided. When the fundamental spirit of the present invention is used, the present invention can be modified in various manners, and these modifications can be easily devised by those skilled in the art with reference to the spirit based on the known word DB 152 and the unknown word DB 154, and belong to the scope of the present invention.

As described above, the language learning apparatus 200 and method using the growing personal word DB system 100 are advantageous in that the individual person-based word DB 150 of each learner in which classification into known words and unknown words is performed and the known words and the unknown words are stored separately is constructed, and the individual person-based word DB 150 is continuously extended through the interactive learning progress of the learner, thus improving the effects of language learning, and configuring and providing dynamic learning content in which differences among learners are reflected via dynamic association between words and text.

Further, the language learning apparatus 200 and method using the growing personal word DB system 100 are advantageous in that word learning services are provided using desired content (for example, e-books, theses, foreign language teaching materials, etc.) to respective learners, thus enhancing learning effects compared to conventional word learning services which use teaching materials produced by uniform standards.

Furthermore, the language learning apparatus 200 and method using the growing personal word DB system 100 are advantageous in that word learning services are provided using learning content such as e-books, theses, and foreign language teaching materials, thus creating the new profit model of publishing companies.

Furthermore, the language learning apparatus 200 and method using the growing personal word DB system 100 are advantageous in that services are provided through smartphones, tablet PCs, etc. in a mobile web environment, thus enabling language learning to be naturally associated with an increase in vocabulary in various environments.

Furthermore, the language learning apparatus 200 and method using the growing personal word DB system 100 are advantageous in that when foreign language text such as English books or English articles is displayed on devices such as a computer or a mobile terminal, words in the text are classified into words learner knows and words the learner does not know and are separately stored in conjunction with DBs, thus allowing the learner to easily learn words and improving the effects of language learning.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A language learning apparatus using a growing personal word database (DB) system, comprising:
a word extraction unit for extracting words included in learning content and generating a word list;
a word analysis unit for setting learning levels of words included in the word list based on a level-based word DB; and
a control unit for generating an individual person-based word DB in which classification into known words and unknown words is performed and the known words and the unknown words are stored separately based on a learning level of a learner and the level-based word DB, and performing control such that the words included in the word list are classified into known words and unknown words and are stored separately based on the set learning level.

2. The language learning apparatus of claim 1, further comprising an input unit for receiving the learning level of the learner and selection information required to classify words into known words and unknown words.

3. The language learning apparatus of claim 1, wherein the word analysis unit classifies the words included in the word list into known words and unknown words based on the set learning level.

4. The language learning apparatus of claim 1, wherein the word analysis unit sets words that are not stored in a basic word DB, among the words included in the word list, to unlearned words.

5. The language learning apparatus of claim 1, wherein the control unit performs control such that words stored in a lower DB, set to a learning level equal to or less than that of the learner, in the level-based word DB are stored in a known word DB.

6. The language learning apparatus of claim 1, wherein the control unit performs control such that words stored in a lower DB, set to a learning level greater than that of the learner, in the level-based word DB are stored in an unknown word DB.

7. The language learning apparatus of claim 1, wherein the control unit displays words classified as unknown words by the word analysis unit and requests the learner to perform an adjustment operation.

8. The language learning apparatus of claim 1, wherein the control unit sets a learning level of learning content based on results of analysis by the word analysis unit.

9. The language learning apparatus of claim 1, further comprising a storage unit formed to have a structure identical to that of the individual person-based word DB and the known words and the unknown words are stored separately in the storage unit.

10. The language learning apparatus of claim 9, wherein the storage unit comprises:
a known word storage module for storing words the learner knows;
an unknown word storage module for storing words the learner does not know;
an unlearned word storage module for storing words that are not stored in the basic word DB; and
a personal level information storage module for storing information including the learning level of the learner.

11. A language learning method using a growing personal word database (DB) system, comprising:
generating an individual person-based word DB in which classification into words a learner knows and words the learner does not know is performed and the known words and unknown words are stored separately based on a learning level of the learner and a level-based word DB;
extending the generated individual person-based word DB using learning content selected by the learner;
analyzing individual person-based learning history using both the individual person-based word DB and a personal learning history DB, and then generating analysis information; and
changing growing personal word DBs based on the generated analysis information.

12. The language learning method of claim 11, wherein the generating the individual person-based word DB comprises:
setting the learning level of the learner; and
detecting words corresponding to a learning level equal to or less than the set learning level of the learner from the level-based word DB and storing the detected words in a known word DB.

13. The language learning method of claim 12, wherein the setting the learning level is configured such that one of an input learning level and a learning level of words stored in the known word DB corresponding to the learner is set to the learning level of the learner.

14. The language learning method of claim 12, wherein the generating the individual person-based word DB is configured such that words corresponding to a learning level greater than the set learning level are detected from the level-based word DB and are stored in an unknown word DB.

15. The language learning method of claim 12, wherein the extending the individual person-based word DB comprises:
extracting a plurality of words from the learning content;
storing words that are not stored in the basic word DB, among the extracted words, in an unlearned word DB of the individual person-based word DB;
storing words corresponding to a learning level equal to or less than that of the learner, among the extracted words, in the known word DB; and
storing words corresponding to a learning level greater than that of the learner, among the extracted words, in the unknown word DB.

16. The language learning method of claim 15, wherein the extending the individual person-based word DB further comprises:
storing words that are not stored in the basic word DB, among the extracted words, in the basic word DB of the individual person-based word DB.

17. The language learning method of claim 15, wherein the storing the words in the unknown word DB comprises:
displaying words corresponding to a learning level greater than that of the learner among the extracted words;
setting words the learner knows, among the displayed words, to known words;
storing the words which are set to the known words in the known word DB; and
storing words which are not set to the known words, among the displayed words, in the unknown word DB.

18. The language learning method of claim 11, wherein the analyzing the individual person-based learning history and generating the analysis information comprises:
managing changed details of the individual person-based word DB;
generating analysis information by analyzing the individual person-based word DB and an individual person-based learning history DB; and
storing the generated analysis information in an individual person-based learning history analysis DB.

19. The language learning method of claim 11, wherein the changing the growing personal word DBs comprises:
changing the basic word DB based on analysis information stored in an individual person-based learning history analysis DB;
resetting learning levels and areas of the words based on the analysis information; and
re-classifying and storing the words based on the reset learning levels and areas.
